(19) United States
(12) Patent Application Publication
(10) Pub. No.: US 2018/0024751 A1
(43) Pub. Date: Jan. 25, 2018

(54) METADATA MANAGEMENT ON A STORAGE DEVICE

(71) Applicant: Western Digital Technologies, Inc., Irvine, CA (US)

(72) Inventors: Zvonimir Z. Bandic, San Jose, CA (US); Jing Shi Booth, San Jose, CA (US); Sanghoon Chu, San Jose, CA (US); Cyril Guyot, San Jose, CA (US); Robert E. Mateescu, San Jose, CA (US); Minghai Qin, San Jose, CA (US); Qingbo Wang, Irvine, CA (US)

(21) Appl. No.: 15/214,386

(22) Filed: Jul. 19, 2016

(51) Int. Cl. G06F 3/06

(52) U.S. Cl. CPC G06F 3/0611; G06F 3/0688; G06F 3/0655

(57) ABSTRACT

A storage device may include a data storage portion including a set of blocks designated to store metadata and a controller. The controller may be configured to write first metadata at a first location designated by a first pointer. The first location may reference a block that does not contain any valid metadata. The controller may be configured to determine a number of valid blocks of previously written metadata in a subset of the set of blocks. A first block of the subset may be at a second location designated by a second pointer. The controller may be configured to, if the number of valid blocks is greater than zero, rewrite the valid previously written metadata to a group of one or more sequential blocks.

### TECHNICAL FIELD

The disclosure relates to data storage management.

### BACKGROUND

Solid-state drives (SSDs) may be used in computers in applications where relatively low latency and high capacity storage are desired. Additionally, SSDs may utilize multiple, parallel data channels to read from and write to memory devices, which may result in high sequential read and write speeds.

SSDs may utilize non-volatile memory (NVM) devices, such as flash, phase change memory (PCM), resistive random access memory (ReRAM), or magnetoresistive random access memory (MRAM) devices. The defragmentation process in an SSD, called “garbage collection,” rewrites valid pages of data (i.e., subunits of blocks of data) from blocks containing a mix of valid and invalid pages to empty blocks and erases the blocks containing a mix of valid and invalid pages to proactively eliminate the need for whole block erasures prior to every write operation. Although garbage collection may efficiently rid SSDs of invalid data and reclaim free blocks, the garbage collection process may significantly reduce the performance of the computing system utilizing the SSD. While metadata is smaller in size than regular user data, systems generally update metadata more often than the regular user data, which leads to the system performing garbage collection on the metadata more often in order to reclaim storage space containing invalid pages.

### SUMMARY

In one example, the disclosure is directed to a method that may include receiving, by a controller, first metadata to write at a first location designated by a first pointer in a data storage portion of a storage device. The data storage portion may comprise a set of blocks designated to store metadata, and the first location designated by the first pointer may reference a block of the set of blocks that does not contain any valid metadata. The method may further include writing, by the controller, the first metadata to the first location. The method may also include determining, by the controller, a number of valid blocks of previously written metadata in a subset of the set of blocks. The subset of the set of blocks may comprise a predetermined number of sequential blocks less than a total number of blocks in the set of blocks, and a sequentially first block of the subset of blocks may be at a second location designated by a second pointer in the data storage portion of the storage device. The method may further include, responsive to determining that the number of valid blocks of previously written metadata is greater than zero, rewriting, by the controller, the valid previously written metadata in the subset of blocks to a group of one or more sequential blocks of the data storage portion. The block referenced by the first location may be sequential with the group of one or more sequential blocks, and a number of blocks in the group of one or more blocks may be equal to the number of valid blocks of previously written metadata in the subset of blocks.

In another example, the disclosure is directed to a storage device that may include a data storage portion and a controller. The data storage portion may comprise a set of blocks designated to store metadata. The controller may be configured to write first metadata at a first location designated by a first pointer in the data storage portion of the storage device. The first location designated by the first pointer references a block of the set of blocks that does not contain any valid metadata. The controller may further be configured to determine a number of valid blocks of previously written metadata in a subset of the set of blocks. The subset of the set of blocks may comprise a predetermined number of sequential blocks less than a total number of blocks in the set of blocks, and a sequentially first block of the subset of blocks may be at a second location designated by a second pointer in the data storage portion of the storage device. The controller may be configured to further, in response to determining that the number of valid blocks of previously written metadata is greater than zero, rewrite the valid previously written metadata in the subset of blocks to a group of one or more sequential blocks of the data storage portion. The block referenced by the first location may be sequential with the group of one or more sequential blocks, and a number of blocks in the group of one or more sequential blocks may be equal to the number of valid blocks of previously written metadata in the subset of blocks.

In another example, the disclosure is directed to a computer-readable medium storing instructions that, when executed, may cause a processor to write first metadata at a first location designated by a first pointer in a data storage portion of a storage device. The data storage portion may comprise a set of blocks designated to store metadata. The first location designated by the first pointer may reference a block of the set of blocks that does not contain any valid metadata. The instructions may also cause the processor determine a number of valid blocks of previously written metadata in a subset of the set of blocks. The subset of the set of blocks may comprise a predetermined number of sequential blocks less than a total number of blocks in the set of blocks, and a sequentially first block of the subset of blocks may be at a second location designated by a second pointer in the data storage portion of the storage device. The instructions may further cause the processor to, in response to determining that the number of valid blocks of previously written metadata is greater than zero, rewrite the valid previously written metadata in the subset of blocks to a group of one or more sequential blocks of the data storage portion. The block referenced by the first location may be sequential with the group of one or more sequential blocks, and a number of blocks in the group of one or more sequential blocks may be equal to the number of valid blocks of previously written metadata in the subset of blocks.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual and schematic block diagram illustrating an example system including a storage device connected to a host device, where the storage device is configured to manage metadata in accordance with one or more techniques of this disclosure.

FIG. 2 is a conceptual block diagram illustrating an example memory device that stores metadata, in accordance with one or more techniques of this disclosure.

FIG. 3 is a conceptual and schematic block diagram illustrating an example controller configured to manage metadata in accordance with one or more techniques of this disclosure.

FIG. 4 is a conceptual and schematic block diagram illustrating example details of a data block that stores metadata that is updated by a controller, in accordance with one or more techniques of this disclosure.

FIG. 5 is a flow diagram illustrating example metadata management operations performed by a controller of a storage device, in accordance with one or more techniques of this disclosure.

### DETAILED DESCRIPTION

The disclosure describes techniques for managing metadata (e.g., a system situation, a file location, a file size, a file creation date, or a pointer that references the file location) for a storage device, such as a solid state drive (SSD), using a static garbage collection algorithm, which may help increase the efficiency and reduce deadlock of the storage device during garbage collection. A storage device may include a data storage portion and a controller. The data storage portion may include at least a set of blocks designated to store metadata. A processor, such as a processor in the controller of the storage device, may maintain two pointers that each point to different locations within the set of blocks designated to store metadata. A first pointer may indicate a location of a block that does not contain any valid metadata. A second pointer may indicate a location of a sequentially first block of a subset of the set of blocks. In general, in accordance with the techniques described herein, the processor may rewrite any valid metadata located in the subset of blocks, as defined by the second pointer, sequentially with received metadata to a group of blocks that includes the block referenced by the first pointer. The processor may then update the location of the first pointer such that the first pointer now references a block that does not contain any valid metadata and is located sequentially after the group where the valid metadata was written. The processor may further update the location of the second pointer such that the second pointer now references a block sequentially after the block previously referenced by the second pointer. For instance, the second pointer may now reference a block that immediately succeeds the final block of the subset. Using the updated pointers, the processor may repeat the process when future metadata is received, whether the received metadata is an update to previously written metadata or new metadata.

In general, the size of the metadata is smaller than other user data. As such, overprovisioning, or utilizing more pages or blocks than necessary to store all valid metadata, is not a critical factor for metadata. However, the system may update metadata more frequently, which may also trigger the garbage collection process more frequently. Upon triggering garbage collection, the system may experience a large latency and a drop in throughput, which can heavily affect the performance of the system. Namely, the system sorting the number of valid pages among all blocks in the set, erasing blocks, and moving valid pages causes the latency. Moreover, garbage collection that is dependent on the workloads (or the logical pages updated) results in latency that is not easily predictable. Rather than performing such garbage collection processes for metadata, the techniques of this disclosure may provide for a static garbage collection process with a low latency and high predictability, as the latency does not depend on the workload. The techniques of this disclosure may further increase the efficiency and reduce deadlock, or a condition where two competing actions are both intending to operate on a same block within the storage device but neither can start until the other finishes, resulting in a case where neither action ever finishes, of the storage device during garbage collection. Further, the techniques described herein incorporate wear leveling with the garbage collection algorithm, and as such may induce no additional latency by separately triggering wear leveling.

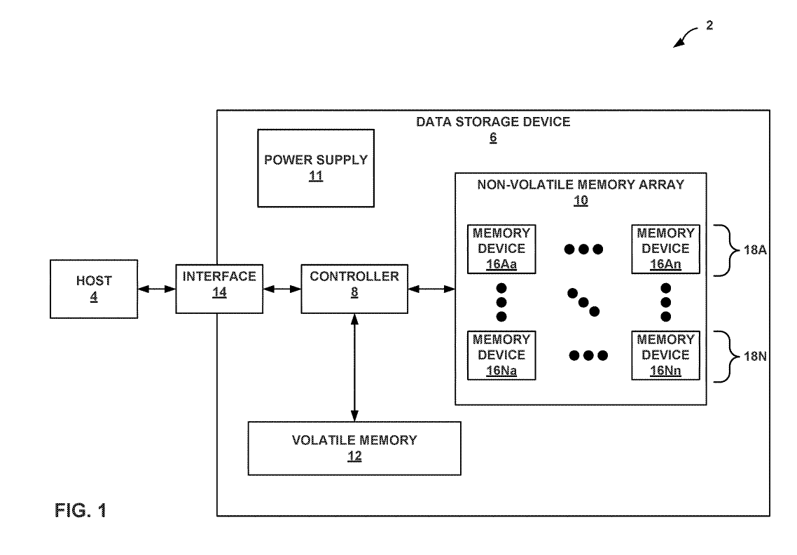

FIG. 1 is a conceptual and schematic block diagram illustrating an example system 2 including storage device 6 that may function as a storage device for host device 4, where storage device 6 is configured to manage metadata in accordance with one or more techniques of this disclosure. For instance, host device 4 may utilize non-volatile memory devices included in storage device 6 to store and retrieve data. In some examples, storage environment 2 may include a plurality of storage devices, such as storage device 6, which may operate as a storage array. For instance, storage environment 2 may include a plurality of storages devices 6 configured as a redundant array of inexpensive/independent disks (RAID) that collectively function as a mass storage device for host device 4.

Storage environment 2 may include host device 4 which may store data to and/or retrieve data from one or more storage devices, such as storage device 6. As illustrated in FIG. 1, host device 4 may communicate with storage device 6 via interface 14. Host device 4 may include any of a wide range of devices, including computer servers, network attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, and the like.

As illustrated in FIG. 1, storage device 6 may include controller 8, non-volatile memory array 10 (NVMA 10), power supply 11, volatile memory 12, and interface 14. In some examples, storage device 6 may include additional components not shown in FIG. 1 for sake of clarity. For example, storage device 6 may include a printed board (PB) to which components of storage device 6 are mechanically attached and which includes electrically conductive traces that electrically interconnect components of storage device 6, or the like. In some examples, the physical dimensions and connector configurations of storage device 6 may conform to one or more standard form factors. Some example standard form factors include, but are not limited to, 3.5″ hard disk drive (HDD) or SSD, 2.5″ HDD or SSD, 1.8″ HDD or SSD, peripheral component interconnect (PCI), PCI-extended (PCI-X), PCI Express (PCIe) (e.g., PCIe x1, x4, x8, x16, PCIe Mini Card, MiniPCI, etc.), M.2, or the like. In some examples, storage device 6 may be directly coupled (e.g., directly soldered) to a motherboard of host device 4.

Storage device 6 may include interface 14 for interfacing with host device 4. Interface 14 may include one or both of a data bus for exchanging data with host device 4 and a control bus for exchanging commands with host device 4. Interface 14 may operate in accordance with any suitable protocol. For example, interface 14 may operate in accordance with one or more of the following protocols: advanced technology attachment (ATA) (e.g., serial-ATA (SATA), and parallel-ATA (PATA)), Fibre Channel, small computer system interface (SCSI), serially attached SCSI (SAS), peripheral component interconnect (PCI), PCI-express, Non-Volatile Memory Express (NVMe), or the like. The electrical connection of interface 14 (e.g., the data bus, the control bus, or both) is electrically connected to controller 8, providing electrical connection between host device 4 and controller 8, allowing data to be exchanged between host device 4 and controller 8. In some examples, the electrical connection of interface 14 may also permit storage device 6 to receive power from host device 4.

Storage device 6 includes NVMA 10, which includes a plurality of memory devices 16Aa-16Nn (collectively, “memory devices 16”). Each of memory devices 16 may be configured to store and/or retrieve data. For instance, a memory device of memory devices 16 may receive data and a message from controller 8 that instructs the memory device to store the data. Similarly, the memory device of memory devices 16 may receive a message from controller 8 that instructs the memory device to retrieve data. In some examples, each of memory devices 16 may be referred to as a die. In some examples, a single physical chip may include a plurality of dies (i.e., a plurality of memory devices 16). In some examples, each of memory devices 16 may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, memory devices 16 may include any type of non-volatile memory devices. Some examples of memory devices 16 include, but are not limited to flash memory devices (e.g., NAND or NOR), phase-change memory (PCM) devices, resistive random-access memory (ReRAM) devices, magnetoresistive random-access memory (MRAM) devices, ferroelectric random-access memory (F-RAM), holographic memory devices, and any other type of non-volatile memory devices. Unlike flash memory devices, PCM devices, ReRAM devices, MRAM devices, and F-RAM devices may not require stale block reclamation (e.g., garbage collection), but still may utilize wear leveling to reduce effects of limited write endurance of individual memory cells.

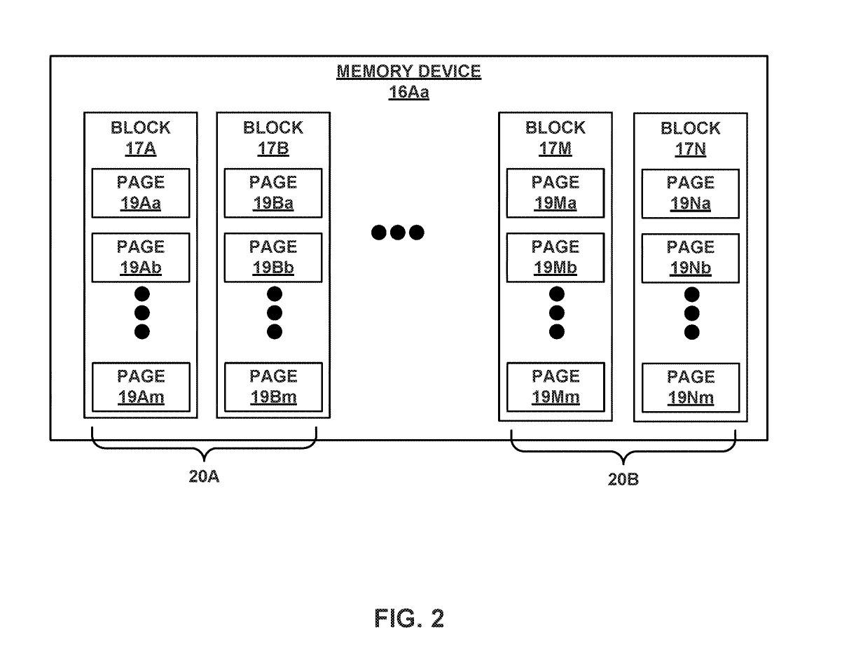

In some examples, memory devices 16 may include flash memory devices. Flash memory devices may include NAND or NOR based flash memory devices, and may store data based on a charge contained in a floating gate of a transistor for each flash memory cell. In NAND flash memory devices, the flash memory device may be divided into a plurality of blocks which may be divided into a plurality of pages. Each block of the plurality of blocks within a particular memory device may include a plurality of NAND cells. Rows of NAND cells may be electrically connected using a word line to define a page of a plurality of pages. Respective cells in each of the plurality of pages may be electrically connected to respective bit lines. In some examples, controller 8 may write data to and read data from NAND flash memory devices at the page level and erase data from NAND flash memory devices at the block level. Additional details of memory devices 16 are discussed below with reference to FIG. 2.

FIG. 2 is a conceptual block diagram illustrating an example memory device 16Aa that includes a plurality of blocks 17A-17N (collectively, “blocks 17”), each block including a plurality of pages 19Aa-19Nm (collectively, “pages 19”). Each block of blocks 17 may include a plurality of NAND cells. Rows of NAND cells may be serially electrically connected using a word line to define a page (one page of pages 19). Respective cells in each of a plurality of pages 19 may be electrically connected to respective bit lines. Controller 8 may write data to and read data from NAND flash memory devices at the page level and erase data from NAND flash memory devices at the block level. A group of two or more blocks may be referred to a logical block address collection. For example, logical block address collection 20A may include blocks 17A-17B and logical block address collection 20B may include blocks 17M-17N.

Returning to FIG. 1, in some examples, it may not be practical for controller 8 to be separately connected to each memory device of memory devices 16. As such, the connections between memory devices 16 and controller 8 may be multiplexed. As an example, memory devices 16 may be grouped into channels 18A-18N (collectively, “channels 18”). For instance, as illustrated in FIG. 1, memory devices 16Aa-16An may be grouped into first channel 18A, and memory devices 16Na-16Nn may be grouped into N^{th} channel 18N. The memory devices 16 grouped into each of channels 18 may share one or more connections to controller 8. For instance, the memory devices 16 grouped into first channel 18A may be attached to a common I/O bus and a common control bus. Storage device 6 may include a common I/O bus and a common control bus for each respective channel of channels 18. In some examples, each channel of channels 18 may include a set of chip enable (CE) lines which may be used to multiplex memory devices on each channel. For example, each CE line may be connected to a respective memory device of memory devices 18. In this way, the number of separate connections between controller 8 and memory devices 18 may be reduced. Additionally, as each channel has an independent set of connections to controller 8, the reduction in connections may not significantly affect the data throughput rate as controller 8 may simultaneously issue different commands to each channel.

Storage device 6 may include power supply 11, which may provide power to one or more components of storage device 6. When operating in a standard mode, power supply 11 may provide power to the one or more components using power provided by an external device, such as host device 4. For instance, power supply 11 may provide power to the one or more components using power received from host device 4 via interface 14. In some examples, power supply 11 may include one or more power storage components configured to provide power to the one or more components when operating in a shutdown mode, such as where power ceases to be received from the external device. In this way, power supply 11 may function as an onboard backup power source. Some examples of the one or more power storage components include, but are not limited to, capacitors, super capacitors, batteries, and the like.

Storage device 6 also may include volatile memory 12, which may be used by controller 8 to store information. In some examples, controller 8 may use volatile memory 12 as a cache. For instance, controller 8 may store cached information in volatile memory 12 until the cached information is written to memory devices 16. Volatile memory 12 may consume power received from power supply 11. Examples of volatile memory 12 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, and the like)).

Storage device 6 includes controller 8, which may manage one or more operations of storage device 6. For example, controller 8 may manage the reading of data from and/or the writing of data to memory devices 16. Controller 8 may interface with host device 4 via interface 14 and manage the storage of data to and the retrieval of data from non-volatile memory 12 and memory devices 16. Controller 8 may, as one example, manage writes to and reads from memory devices 16 and non-volatile memory 12. In some examples, controller 8 may be a hardware controller. In other examples, controller 8 may be implemented into data storage device 6 as a software controller.

When writing a file to a memory device 16 in NVMA 10, controller 8 may either receive metadata associated with the file or create metadata associated with the file. This metadata may include a system situation, a file location, a file size, a file creation date, a pointer that references the file location, or the like. This metadata is rewritten often, as the metadata may change each time the file is accessed, moved, altered, deleted, or copied. This frequent modification of the metadata can lead to increased write amplification or wear leveling requirements within the memory device in NVMA 10 that stores the metadata. Garbage collection, which is a defragmentation-like method for handling the blocks of invalid metadata, may efficiently rid NVMA 10 of invalid data and reclaim free blocks, though the garbage collection process may significantly reduce the performance of the computing system (e.g., host device 4) utilizing NVMA 10 during the garbage collection process. As such, the techniques presented herein describe a static garbage collection algorithm for controller 8 to efficiently and reliably perform wear leveling and garbage collection of metadata stored and updated within NVMA 10.

In accordance with the techniques of this disclosure, in some examples, controller 8 may receive first metadata from host device 4 via interface 14. Controller 8 may also receive an indication or determine to write the first metadata at a first location designated by a first pointer in NVMA 10. As described above, each memory device 16 in NVMA 10, such as memory device 16Aa, includes a plurality of blocks, or a set of blocks. In some examples, the first location designated by the first pointer may reference a block of the set of blocks in memory device 16Aa that does not contain any valid metadata. For instance, controller 8 may receive metadata containing file information from host device 4 that is to be written at a block with an index equal to 12 (i.e., a thirteenth sequential block in the set of blocks) in memory device 16Aa. Once the first metadata is received, controller 8 may write the first metadata (e.g., the file information) to the first location (e.g., the thirteenth block in the set of blocks in memory device 16Aa).

In other examples, instead of receiving the first metadata, controller 8 may itself create the metadata to be written to the block with an index equal to 12. In other words, controller 8 may create the metadata containing the file information, before, during, or after writing the file described by the file information to NVMA 10. In such examples, after creating the first metadata, controller 8 may write the first metadata to the first location.

Controller 8 may further determine a number of valid blocks of previously written metadata in a subset of the set of blocks. The subset of the set of blocks may include a predetermined number of sequential blocks less than a total number of blocks in the set of blocks, and a sequentially first block of the subset of blocks may be at a second location designated by a second pointer in the data storage portion of the storage device. For instance, the entire set of blocks may include a large number of blocks, such as 128. The subset may include a smaller predetermined number of sequential blocks, such as three blocks. If the second pointer references a block with an index equal to 0 (i.e., a first sequential block in the set of blocks) in memory device 16Aa, then the subset may include the three blocks in the set of blocks in memory device 16Aa with index numbers equal to 0, 1, and 2. As such, controller 8 may determine whether any of the three blocks in the subset contain valid, previously written metadata and track how many of the subset blocks contain valid, previously written metadata.

In response to determining that the number of valid blocks of previously written metadata is greater than zero, controller 8 may rewrite the valid previously written metadata in the subset of blocks to a group of one or more sequential blocks of the data storage portion. The block referenced by the first location may be sequential with the group of one or more sequential blocks, and a number of blocks in the group of one or more blocks may be less than or equal to the number of valid blocks of previously written metadata in the subset of blocks. For instance, controller 8 may determine that only the block with an index equal to 1 contains valid, previously written metadata. As such, controller 8 may rewrite the valid metadata in the block with an index equal to 1 to a block that is sequential with the block referenced by the first pointer (i.e., the block with an index equal to 12). That is, controller 8 may rewrite the metadata stored in the block with an index equal to 1 to a block with an index equal to either 11 or 13 so that the rewritten metadata is stored sequentially with the received first metadata.

In such instances, an overprovisioning of NVMA 10 of (1/(k−1))*100% may be sufficient to prevent deadlocks in the memory device that stores the metadata, where k is equal to the number of blocks in the subset of blocks. In accordance with the techniques of this disclosure, overprovisioning means a number of blocks reserved as extra space for write operations, often written as a percentage of the number of valid blocks. For instance, an overprovisioning of 100% means that the number of extra blocks reserved as extra space for write operations is equal to the number of blocks reserved for storing metadata. The write amplification in this example may be k (e.g., the actual amount of physical information written is a multiple of the logical amount intended to be written). While such overprovisioning and write amplification may have a negative effect on NVMA 10 if these techniques were used for all types of data, the portion of NVMA 10 needed to store metadata is very small in relation to the entirety of NVMA 10. As such, any negative effects of overprovisioning and the write amplification are mitigated.

In preparation for controller 8 executing the next static garbage collection after receiving additional metadata, controller 8 may update the locations referenced by the two pointers. For instance, controller 8 may update the first pointer to reference a block that is sequentially later than the first location, such as a block with an index equal to 13 (if the metadata was rewritten to the block with the index equal to 11) or a block with an index equal to 14 (if the metadata was rewritten to the block with the index equal to 13). Further, controller 8 may update the second pointer to reference a block that immediately succeeds the last block of the subset. For instance, controller 8 may update the second pointer to reference a block with an index equal to 3 (i.e., the fourth sequential block of the set of blocks).

Rewriting the valid metadata causes the entire subset to either be empty or contain invalid data that can be erased prior to or during future writes. Rather than performing full garbage collection processes for metadata, by performing a static garbage collection process with a low latency and high predictability upon writing an instance of metadata, the latency does not depend on the workload. Instead, a small portion of the set of blocks undergoes the garbage collection process so that the entire set of blocks does not undergo the garbage collection process all at once. The techniques of this disclosure may further increase the efficiency and reduce deadlock of the storage device during garbage collection. Further, the techniques described herein may induce no additional latency by triggering wear leveling, as the wear leveling processes are part of the static garbage collection technique due to the sequentially moving pointers.

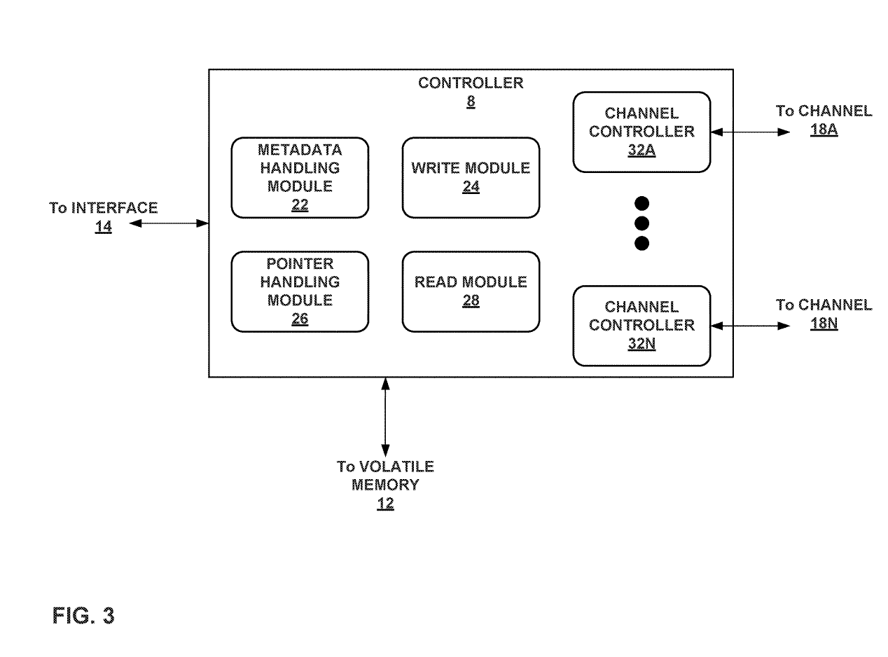

FIG. 3 is a conceptual and schematic block diagram illustrating an example controller 8 configured to manage metadata in accordance with one or more techniques of this disclosure. In some examples, controller 8 may include metadata handling module 22, write module 24, pointer handling module 26, read module 28, and a plurality of channel controllers 32A-32N (collectively, “channel controllers 32”). In other examples, controller 8 may include additional modules or hardware units, or may include fewer modules or hardware units. Controller 8 may include one or more microprocessors, digital signal processors (DSP), application specific integrated circuits (ASIC), field programmable gate arrays (FPGA), or other digital logic circuitry.

Controller 8 may interface with the host device 4 via interface 14 and manage the storage of data to and the retrieval of data from memory devices 16. For example, write module 24 of controller 8 may manage writes to memory devices 16. For example, write module 24 may receive a message from host device 4 via interface 14 instructing storage device 6 to store data associated with a logical address and the data, which may be referred to as user data. Write module 24 may manage writing of the user data to memory devices 16.

For example, write module 24 may manage translation between logical addresses used by host device 4 to manage storage locations of data and physical block addresses used by write module 24 to direct writing of data to memory devices. Write module 24 of controller 8 may utilize a flash translation layer or indirection table that translates logical addresses (or logical block addresses) of data stored by memory devices 16 to physical block addresses of data stored by memory devices 16. For example, host device 4 may utilize the logical block addresses of the data stored by memory devices 16 in instructions or messages to storage device 6, while write module 24 utilizes physical block addresses of the data to control writing of data to memory devices 16. (Similarly, read module 28 may utilize physical block addresses to control reading of data from memory devices 16.) The physical block addresses correspond to actual, physical blocks of memory devices 16. In some examples, write module 24 may store the flash translation layer or table in volatile memory 12. Upon receiving the one or more physical block addresses, write module 24 may define and/or select one or more physical blocks, and communicate a message to channel controllers 32A-32N (collectively, “channel controllers 32”), which causes the channel controllers 32 to write the data to the physical blocks.

Each channel controller of channel controllers 32 may be connected to a respective channel of channels 18. In some examples, controller 8 may include the same number of channel controllers 32 as the number of channels 18 of storage device 2. Channel controllers 32 may perform the intimate control of addressing, programming, erasing, and reading of memory devices 16 connected to respective channels, e.g., under control of write module 24 and/or read module 28.

When writing a file to a memory device 16 in NVMA 10, metadata handling module 22 may either receive metadata associated with the file or create metadata associated with the file. This metadata may include a system situation, a file location, a file size, a file creation date, a pointer that references the file location, or the like. Metadata handling module 22 may rewrite metadata relatively often, as the metadata may change each time the file is accessed, moved, altered, deleted, or copied. This frequent modification of the metadata can lead to increased write amplification within the memory device in NVMA 10 that stores the metadata, which may be addressed by additional garbage collection. Garbage collection may significantly reduce the performance of the computing system (e.g., host device 4) utilizing NVMA 10 during the garbage collection process. As such, the techniques presented herein describe a static garbage collection algorithm for controller 8 to efficiently and reliably handle metadata stored and updated within NVMA 10.

In accordance with the techniques of this disclosure, metadata handling module 22 may receive first metadata from host device 4 via interface 14. Metadata handling module 22 may also receive an indication or determine to write the first metadata at a first location designated by a first pointer in NVMA 10. As described above, each memory device 16 in NVMA 10, such as memory device 16Aa, includes a plurality of blocks, or a set of blocks. In some examples, the first location designated by the first pointer may reference a block of the set of blocks that makes up memory device 16Aa that does not contain any valid metadata. For instance, metadata handling module 22 may receive metadata containing file size information from host device 4 that is to be written at a block with an index equal to 27 (i.e., a twenty-eighth sequential block in the set of blocks) in memory device 16Aa. Once the first metadata is received, write module 24 may write the first metadata (e.g., the file information) to the first location (e.g., the twenty-eighth block in the set of blocks in memory device 16Aa).

In other examples, metadata handling module 22 may itself create the metadata to be written to the block with an index equal to 27. In other words, metadata handling module 22 may create the metadata containing the file size information, such as before, during, or after write module 24 writes the file described by the file size information to NVMA 10. In such examples, after creating the first metadata, write module 24 may further write the first metadata to the first location.

Metadata handling module 22 may further determine a number of valid blocks of previously written metadata in a subset of the set of blocks. The subset of the set of blocks may include a predetermined number of sequential blocks less than a total number of blocks in the set of blocks that store metadata, and a sequentially first block of the subset of blocks may be at a second location designated by a second pointer in the data storage portion of the storage device (e.g., memory device 16Aa). For instance, the entire set of blocks may include a large number of blocks, such as 256 blocks. The subset may include a smaller predetermined number of sequential blocks, such as two blocks, three blocks, or the like. If the second pointer references a block with an index equal to 10 (i.e., an eleventh sequential block in the set of blocks) in memory device 16Aa, then the subset may include the two blocks in the set of blocks in memory device 16Aa with index numbers equal to 10 and 11. As such, metadata handling module 22 may determine whether any of the two blocks in the subset contain valid, previously written metadata and track how many of the subset blocks contain valid, previously written metadata.

In response to determining that the number of valid blocks of previously written metadata is greater than zero, write module 24 may rewrite the valid previously written metadata in the subset of blocks to a group of one or more sequential blocks of the data storage portion (e.g., memory device 16Aa). The block referenced by the first location may be sequential with the group of one or more sequential blocks, and a number of blocks in the group of one or more blocks may be less than or equal to the number of valid blocks of previously written metadata in the subset of blocks.

In some examples, metadata handling module 22 may determine that both blocks in the subset contain valid, previously written metadata. In one instance, write module 24 may rewrite the valid metadata in both of the blocks in the subset to blocks that are sequential with the block referenced by the first pointer (i.e., the block with an index equal to 27). That is, write module 24 may rewrite the metadata stored in the blocks with indexes equal to 10 and 11 to a block with indexes equal to either 25 and 26 or 28 and 29 so that the rewritten metadata is stored sequentially with the received first metadata. In such instances, an overprovisioning of NVMA 10 of 100% may be sufficient to prevent deadlocks in the memory device that stores the metadata. In accordance with the techniques of this disclosure, overprovisioning means a number of blocks reserved as extra space for write operations, often written as a percentage of the number of valid blocks. For instance, an overprovisioning of 100% means that the number of extra blocks reserved as extra space for write operations is equal to the number of blocks reserved for storing metadata. The write amplification in this example may be 2.

In other instances, write module 24 may rewrite the metadata stored in the blocks with indexes equal to 10 and 11 to the first block and a block sequentially following the first block (i.e., blocks with indexes equal to 27 and 28). In such instances, write module 24 may write the received first metadata to a block following this group (i.e., a block with an index equal to 29) rather than the first location. In other words, while techniques of this disclosure may describe writing the received metadata to the first location and writing the previously written valid metadata sequentially to the first location, it is contemplated that the order may be reversed, and upon receiving or creating the first metadata, metadata handling module 22 may analyze the subset of blocks for any valid metadata, rewrite the valid metadata to the first location, and then write the received or created first metadata following the rewritten valid metadata.

In other instances, when every block in the subset contains valid metadata, write module 24 may only rewrite a portion of the valid metadata in the subset. For instance, if metadata handling module 22 determines that both blocks in the subset contain valid, previously written metadata, write module 24 may only rewrite the first block of the subset of blocks to a block locates sequentially to the first block. That is, write module 24 may rewrite the metadata stored in the block with an index equal to 10 to a block with an index equal to either 26 or 28 so that the rewritten metadata is stored sequentially with the received first metadata. Since the purpose of garbage collection is to free up blocks that no longer contain valid metadata, if every block in the subset of blocks contains valid metadata, rewriting the entire subset may be an unnecessary use of processing power. As such, write module 24 may only rewrite a portion of the subset of blocks that all contain valid metadata rather than rewriting the entirety of the subset. In such instances, the overprovisioning of NVMA 10 for the memory device that holds the metadata may be sufficient at 100%. The write amplification may be approximately 1.75 if there is a uniform workload.

In still other instances, the blocks in the subset that contain valid metadata may only have certain pages that contain valid metadata. In other words, some pages of a block in the subset may contain valid metadata, while other pages in the block in the subset may be empty or contain invalid metadata. In the example of FIG. 2, metadata handling module 22 may determine that both blocks of the subset contain valid metadata. However, one or both of these blocks may also include pages that contain invalid metadata or no metadata at all. In such examples, write module 24 may only rewrite the pages of the two blocks in the subset that contain valid metadata. The first pointer may reference a page within the first block. Write module 24 may then write the received first metadata and each page that contains valid metadata from the blocks of the subset sequentially, starting at the page referenced within the first block. This grouping of metadata may carry over to a next sequential block to the first block in examples in which the valid metadata and received first metadata consume more than the remaining pages in the first block. In such instances, the overprovisioning of NVMA 10 for the memory device that holds the metadata may be sufficient at 100%. The write amplification may be 2.

In preparation for controller 8 executing the next static garbage collection after receiving additional metadata, pointer handling module 26 may update the locations referenced by the two pointers. For instance, pointer handling module 26 may update the first pointer to reference a block that is sequentially later than the first location, e.g., sequentially later by the amount of data (measured in pages or blocks) written to the first location and any sequentially later blocks.

For example, in instances in which write module 24 rewrites entire blocks of previously written valid metadata, pointer handling module 26 may update the first pointer as follows. The variable c may be equal to an index of the first location. The variable k may indicate the predetermined number of sequential blocks in the subset of blocks. Finally, the variable i may indicate one more than the number of blocks in the group of one or more sequential blocks (i.e., the amount of blocks in the subset of blocks that are rewritten by write module 24) to account for the rewritten blocks as well as the first metadata. In such examples, pointer handling module 26 may update the first pointer based on the following equation:

c=c+i

wherein 1≦i≦k+1. In the example of FIG. 2, c is equal to 27 (i.e., the index of the first location), and i is equal to 3 (i.e., 1 more than the 2 blocks in the subset that are rewritten). As such, the updated index c referenced by the first pointer is equal to 30. Similarly, in the example where write module 24 rewrites only one of the two blocks that contain valid metadata, i is only equal to 2, meaning that the updated index c referenced by the first pointer is equal to 29.

As another example, in examples in which write module 24 rewrites only the pages of the blocks of the subset of blocks that contain valid metadata, pointer handling module 26 may update the first pointer as follows. The variable c may be equal to an index of a page in the first block referenced by the first location. The variable q may be equal to a number of valid pages of metadata present in the subset of blocks, and the variable pg_per_blk comprises a total number of pages in a single block of the set of blocks. In such examples, pointer handling module 26 may update the first pointer based on the following equation:

c=c+q+pg_per_blk

For instance, in the example of FIG. 2, each block may contain 128 pages. Metadata handling module 22 may determine that the two blocks in the subset of blocks contain a total of 134 pages of valid metadata. Further, c may reference a 59^{th} page of the block with an index of 27. In such an instance, the first pointer may advance a total of 262 total pages, meaning that the updated index c may reference a 65^{th} page of the block with an index of 29.

Further, pointer handling module 26 may update the second pointer to reference a block that immediately succeeds the last block of the subset as follows. The variable p may equal an index of the second location. The variable k may be equal to the predetermined number of sequential blocks in the subset of blocks, such as 2 or 3. In such examples, pointer handling module 26 may update the second pointer based on the following equation:

p=p+k

As such, pointer handling module 26 may update the index p for the second pointer to reference a block with an index equal to 12 (i.e., the thirteenth sequential block of the set of blocks).

In other instances, where write module 24 does not rewrite the entirety of the subset of blocks if each block in the subset of blocks contains valid, previously written metadata, pointer handling module 26 may update the second pointer as follows. The variable p₁ may equal an index of the second location. The variable p₂ may equal an index of the second block. The variable k may be equal to the predetermined number of sequential blocks in the subset of blocks. Finally, the variable s may be equal to the number of valid blocks of previously written metadata in the subset of blocks. In such examples, pointer handling module 26 may update the second pointer based on the following equation:

p₂=p₁+k, if k>s, and

p₂=p₁+(k−1), if k=s

As such, in examples in which both blocks of the subset contain valid, previously written metadata, rather than increasing the previous index by 2, pointer handling module 26 may update the index to equal p₂ and to reference a block with an index equal to 11.

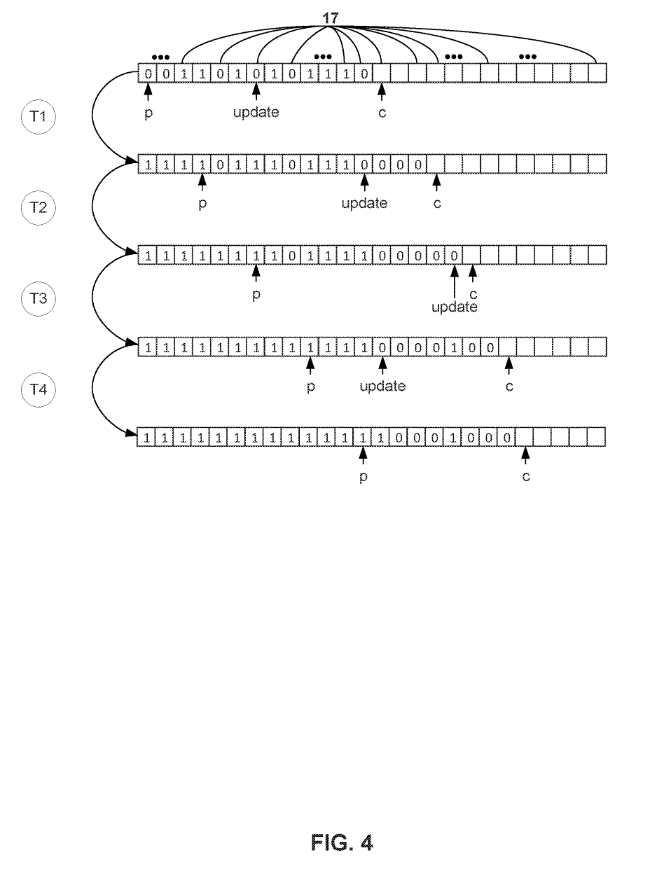

FIG. 4 is a conceptual and schematic block diagram illustrating example details of a plurality of data blocks that store metadata that is updated by a controller, in accordance with one or more techniques of this disclosure. For ease of illustration, the exemplary technique of FIG. 4 will be described with concurrent reference to data blocks 17A-17N (herein after “data blocks 17) of memory device 16Aa and controller 8 of FIGS. 1, 2, and 3. However, the techniques may be used with any combination of hardware or software.

For instance, the array of squares in FIG. 4 may represent at least a portion of the data blocks 17A-17N that make up memory device 16Aa, where each square in the array represents a single data block. For ease of illustration, data blocks 17 that contain a 0 hold valid, previously written metadata, while data blocks 17 that contain a 1 hold invalid metadata or no metadata at all. The pointer c in FIG. 4 represents the first pointer where metadata will be written to memory device 16Aa. The pointer p in FIG. 4 represents the location of a first data block in the subset of data blocks that will be analyzed for containing valid, previously written metadata. For the purposes of this illustration, the subset of data blocks contains three blocks.

In accordance with the techniques of this disclosure, at time T1, controller 8 may receive or create metadata that consists of an update to the metadata previously written to the seventh data block in memory device 16Aa, indicated by the “update” notation in the first row of FIG. 4. Once this metadata is realized, controller 8 may determine which data blocks in the subset beginning at pointer p (i.e., the first, second, and third data blocks of memory device 16Aa) contain valid metadata. In this instance, controller 8 determines that the first and the second block contain valid, previously written metadata. As such, controller 8 may write the received or created metadata (i.e., the update to the seventh data block) sequentially with the metadata from the first and second data blocks beginning at location c (i.e., the fourteenth data block). Controller 8 may then update pointer p to reference the fourth data block (i.e., the data block that sequentially follows the final data block of the subset of data blocks one through three). Controller 8 may also update pointer c to reference the seventeenth data block (i.e., the data block that sequentially follows the newly written/rewritten metadata). Finally, controller 8 may update the seventh data block to indicate that the seventh data block no longer contains valid metadata. The outcome of these operations is illustrates in the second row of FIG. 4.

At time T2, controller 8 may receive or create metadata that consists of an update to the metadata previously written to the thirteenth data block in memory device 16Aa, indicated by the “update” notation in the second row of FIG. 4. Once this metadata is realized, controller 8 may determine which data blocks in the subset beginning at pointer p (i.e., the fourth, fifth, and sixth data blocks of memory device 16Aa) contain valid metadata. In this instance, controller 8 determines that the fifth block contains valid, previously written metadata. As such, controller 8 may write the received or created metadata (i.e., the update to the thirteenth data block) sequentially with the metadata from the fifth data block beginning at location c (i.e., the seventeenth data block). Controller 8 may then update pointer p to reference the seventh data block (i.e., the data block that sequentially follows the final data block of the subset of data blocks four through six). Controller 8 may also update pointer c to reference the nineteenth data block (i.e., the data block that sequentially follows the newly written/rewritten metadata). Finally, controller 8 may update the thirteenth data block to indicate that the thirteenth data block no longer contains valid metadata. The outcome of these operations is illustrates in the third row of FIG. 4.

At time T3, controller 8 may receive or create metadata that consists of an update to the metadata previously written to the eighteenth data block in memory device 16Aa, indicated by the “update” notation in the third row of FIG. 4. Once this metadata is realized, controller 8 may determine which data blocks in the subset beginning at pointer p (i.e., the seventh, eighth, and ninth data blocks of memory device 16Aa) contain valid metadata. In this instance, controller 8 determines that the ninth block contains valid, previously written metadata. As such, controller 8 may write the received or created metadata (i.e., the update to the eighteenth data block) sequentially with the metadata from the ninth data block beginning at location c (i.e., the nineteenth data block). Controller 8 may then update pointer p to reference the tenth data block (i.e., the data block that sequentially follows the final data block of the subset of data blocks seven through nine). Controller 8 may also update pointer c to reference the twenty-first data block (i.e., the data block that sequentially follows the newly written/rewritten metadata). Finally, controller 8 may update the eighteenth data block to indicate that the eighteenth data block no longer contains valid metadata. The outcome of these operations is illustrates in the fourth row of FIG. 4.

At time T4, controller 8 may receive or create metadata that consists of an update to the metadata previously written to the fourteenth data block in memory device 16Aa, indicated by the “update” notation in the fourth row of FIG. 4. Once this metadata is realized, controller 8 may determine which data blocks in the subset beginning at pointer p (i.e., the tenth, eleventh, and twelfth data blocks of memory device 16Aa) contain valid metadata. In this instance, controller 8 determines that the no blocks contain valid, previously written metadata. As such, controller 8 may write the received or created metadata (i.e., the update to the fourteenth data block) singularly beginning at location c (i.e., the twenty-first data block). Controller 8 may then update pointer p to reference the thirteenth data block (i.e., the data block that sequentially follows the final data block of the subset of data blocks ten through twelve). Controller 8 may also update pointer c to reference the twenty-second data block (i.e., the data block that sequentially follows the newly written metadata). Finally, controller 8 may update the fourteenth data block to indicate that the fourteenth data block no longer contains valid metadata. The outcome of these operations is illustrates in the fifth row of FIG. 4.

FIG. 4 illustrates one example of how controller 8 may update the positions of pointers p and c in response to writing metadata. In other examples, as described with reference to FIG. 3, controller 8 may update the positions of pointers p and c differently, e.g., controller 8 may update the position of pointer p based on a number of valid metadata pages or blocks in the subset of blocks. Similarly, although the number of blocks in the subset of blocks is illustrated to be three in FIG. 4, in other examples, the number of blocks in the subset of blocks may be more or less than three.

As shown in the example of FIG. 4, the disclosed static wear leveling algorithms result in both wear leveling and garbage collection being performed on the blocks storing the metadata in a single operation, and is triggered by writing new metadata or updating previously written metadata. Further, by updating the locations of pointers p and c according to the techniques described herein, deadlock may be avoided.

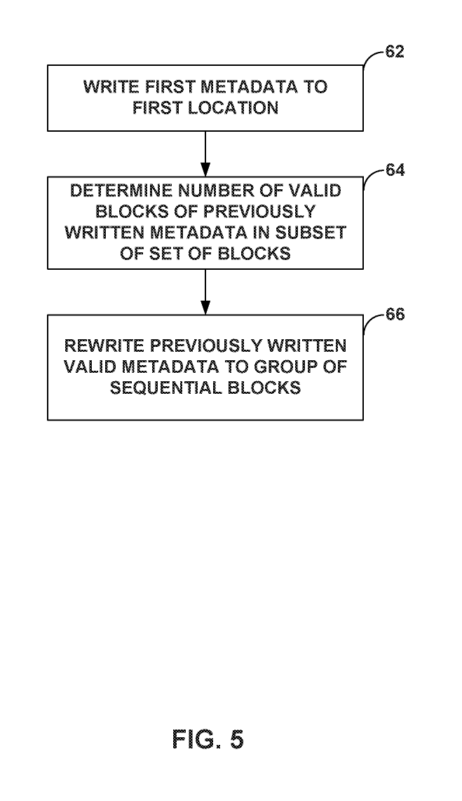

FIG. 5 is a flow diagram illustrating example metadata management operations performed by a controller of a storage device, in accordance with one or more techniques of this disclosure. For ease of illustration, the exemplary technique of FIG. 5 will be described with concurrent reference to storage device 6 and controller 8 of FIGS. 1 and 3. However, the techniques may be used with any combination of hardware or software.

In accordance with the techniques of this disclosure, in some examples, controller 8 may receive first metadata from host device 4 via interface 14. Controller 8 may also receive an indication or determine to write the first metadata at a first location designated by a first pointer in NVMA 10. As described above, each memory device 16 in NVMA 10, such as memory device 16Aa, includes a plurality of blocks, or a set of blocks. In some examples, the first location designated by the first pointer may reference a block of the set of blocks in memory device 16Aa that does not contain any valid metadata. For instance, controller 8 may receive metadata containing file information from host device 4 that is to be written at a block with an index equal to 73 (i.e., a seventy-fourth sequential block in the set of blocks) in memory device 16Aa. Once the first metadata is received, controller 8 may write the first metadata (e.g., the file information) to the first location (e.g., the seventy-fourth block in the set of blocks in memory device 16Aa) (62).

In other examples, instead of receiving the first metadata, controller 8 may itself create the metadata to be written to the block with an index equal to 12. In other words, controller 8 may create the metadata containing the file information before, during, or after writing the file described by the file information to NVMA 10. In such examples, after creating the first metadata, controller 8 may write the first metadata to the first location (62).

Controller 8 may further determine a number of valid blocks of previously written metadata in a subset of the set of blocks (64). The subset of the set of blocks may include a predetermined number of sequential blocks less than a total number of blocks in the set of blocks, and a sequentially first block of the subset of blocks may be at a second location designated by a second pointer in the data storage portion of the storage device. For instance, the entire set of blocks may include a large number of blocks, such as 128. The subset may include a smaller predetermined number of sequential blocks, such as two blocks. If the second pointer references a block with an index equal to 34 (i.e., a thirty-fifth sequential block in the set of blocks) in memory device 16Aa, then the subset may include the two blocks in the set of blocks in memory device 16Aa with index numbers equal to 34 and 35. As such, controller 8 may determine whether any of the two blocks in the subset contain valid, previously written metadata and track how many of the subset blocks contain valid, previously written metadata.

In response to determining that the number of valid blocks of previously written metadata is greater than zero, controller 8 may rewrite the valid previously written metadata in the subset of blocks to a group of one or more sequential blocks of the data storage portion (66). The block referenced by the first location may be sequential with the group of one or more sequential blocks, and a number of blocks in the group of one or more blocks may be less than or equal to the number of valid blocks of previously written metadata in the subset of blocks. For instance, controller 8 may determine that only the block with an index equal to 35 contains valid, previously written metadata. As such, controller 8 may rewrite the valid metadata in the block with an index equal to 35 to a block that is sequential with the block referenced by the first pointer (i.e., the block with an index equal to 73). That is, controller 8 may rewrite the metadata stored in the block with an index equal to 35 to a block with an index equal to either 72 or 74 so that the rewritten metadata is stored sequentially with the received first metadata. In other instances, controller 8 may instead rewrite the metadata stored in the block with an index equal to 35 to the block referenced by the first pointer (i.e., the block with an index equal to 73), then write the received or created first metadata to a block sequential with the block referenced by the first pointer (i.e., a block with an index equal to either 72 or 74).

### EXAMPLE 1

A method comprising: writing, by the controller, first metadata at a first location designated by a first pointer in a data storage portion of a storage device, wherein the data storage portion comprises a set of blocks designated to store metadata, and wherein the first location designated by the first pointer references a block of the set of blocks that does not contain any valid metadata; determining, by the controller, a number of valid blocks of previously written metadata in a subset of the set of blocks, wherein the subset of the set of blocks comprises a predetermined number of sequential blocks less than a total number of blocks in the set of blocks, and wherein a sequentially first block of the subset of blocks is at a second location designated by a second pointer in the data storage portion of the storage device; and in response to determining that the number of valid blocks of previously written metadata is greater than zero, rewriting, by the controller, the valid previously written metadata in the subset of blocks to a group of one or more sequential blocks of the data storage portion, wherein the block referenced by the first location is sequential with the group of one or more sequential blocks, and wherein a number of blocks in the group of one or more sequential blocks is less than or equal to the number of valid blocks of previously written metadata in the subset of blocks.

### EXAMPLE 2

The method of example 1, further comprising: updating, by the controller, the first pointer to reference a second block at a third location, wherein the second location of the third block sequentially succeeds either the first location of the first block or a final sequential block of the group of one or more sequential blocks.

### EXAMPLE 3

The method of example 2, wherein c comprises an index of the first location, and wherein updating the first location comprises updating c based on:

c=c+i,

wherein 1<i<k+1, wherein k comprises the predetermined number of sequential blocks in the subset of blocks, and wherein i comprises one more than the number of blocks in the group of one or more sequential blocks.

### EXAMPLE 4

The method of example 2, wherein c comprises an index of a page in the first block referenced by the first location, and wherein updating the first location comprises updating c based on:

c=c+q+pg_per_blk,

wherein q comprises a number of valid pages of metadata present in the subset of blocks, and wherein pg_per_blk comprises a total number of pages in a singular block of the set of blocks.

### EXAMPLE 5

The method of any of examples 1-4, further comprising: updating, by the controller, the second pointer to reference a second block at a third location, wherein the second block sequentially succeeds a final sequential block of the subset of blocks.

### EXAMPLE 6

The method of example 5, wherein p comprises an index of the second location, and wherein updating the second location comprises updating p based on:

p=p+k,

wherein k comprises the predetermined number of sequential blocks in the subset of blocks.

### EXAMPLE 7

The method of example 6, wherein k equals either 2 or 3.

### EXAMPLE 8

The method of any of examples 1-4, further comprising: updating, by the controller, the second pointer to reference a second block at a third location, wherein p1 comprises an index of the second location, wherein p2 comprises an index of the second block, and wherein:

p2=p1+k, if k>s, and

p2=p1+(k−1), if k=s,

wherein k comprises the predetermined number of sequential blocks in the subset of blocks, and wherein s comprises the number of valid blocks of previously written metadata in the subset of blocks.

### EXAMPLE 9

The method of any of examples 1-8, wherein the first metadata comprises an update to previously written metadata stored in the data storage portion of the storage device.

### EXAMPLE 10

The method of any of examples 1-9, wherein the first metadata comprises one of a system situation, a file location, a file size, a file creation date, or a third pointer that references the file location.

### EXAMPLE 11

A storage device comprising: a data storage portion comprising a set of blocks designated to store metadata; and a controller configured to: write first metadata at a first location designated by a first pointer in the data storage portion of the storage device, wherein the first location designated by the first pointer references a block of the set of blocks that does not contain any valid metadata; determine a number of valid blocks of previously written metadata in a subset of the set of blocks, wherein the subset of the set of blocks comprises a predetermined number of sequential blocks less than a total number of blocks in the set of blocks, and wherein a sequentially first block of the subset of blocks is at a second location designated by a second pointer in the data storage portion of the storage device; and in response to determining that the number of valid blocks of previously written metadata is greater than zero, rewrite the valid previously written metadata in the subset of blocks to a group of one or more sequential blocks of the data storage portion, wherein the block referenced by the first location is sequential with the group of one or more sequential blocks, and wherein a number of blocks in the group of one or more sequential blocks is less than or equal to the number of valid blocks of previously written metadata in the subset of blocks.

### EXAMPLE 12

The storage device of example 11, wherein the controller is further configured to: update the first pointer to reference a second block at a third location, wherein the third location of the second block sequentially succeeds either the first location of the first block or a final sequential block of the group of one or more sequential blocks.

### EXAMPLE 13

The storage device of example 12, wherein c comprises an index of the first location, and wherein the controller being configured to update the first location comprises the controller being configured to update c based on:

c=c+i,

wherein 1<i<k+1, wherein k comprises the predetermined number of sequential blocks in the subset of blocks, and wherein i comprises one more than the number of blocks in the group of one or more sequential blocks.

### EXAMPLE 14

The storage device of example 12, wherein c comprises an index of a page in the first block referenced by the first location, and wherein the controller being configured to update the first location comprises the controller being configured to update c based on:

c=c+q+pg_per_blk,

wherein q comprises a number of valid pages of metadata present in the subset of blocks, and wherein pg_per_blk comprises a total number of pages in a singular block of the set of blocks.

### EXAMPLE 15

The storage device of any of examples 11-14, wherein the controller is further configured to: update the second pointer to reference a second block at a third location, wherein the second block sequentially succeeds a final sequential block of the subset of blocks.

### EXAMPLE 16

The storage device of example 15, wherein p comprises an index of the second location, and wherein the controller being configured to update the second location comprises the controller being configured to update p based on:

p=p+k,

wherein k comprises the predetermined number of sequential blocks in the subset of blocks, and wherein k equals either 2 or 3.

### EXAMPLE 17

The storage device of any of examples 11-14, further comprising: update the second pointer to reference a second block at a third location, wherein p1 comprises an index of the second location, wherein p2 comprises an index of the second block, and wherein:

p2=p1+k, if k>s, and

p2=p1+(k−1), if k=s,

wherein k comprises the predetermined number of sequential blocks in the subset of blocks, and wherein s comprises the number of valid blocks of previously written metadata in the subset of blocks.

### EXAMPLE 18

The storage device of any of examples 11-17, wherein the first metadata comprises an update to previously written metadata stored in the data storage portion of the storage device.

### EXAMPLE 19

The storage device of any of examples 11-18, wherein the first metadata comprises one of a system situation, a file location, a file size, a file creation date, or a third pointer that references the file location.

### EXAMPLE 20

A computer-readable storage medium storing instructions that, when executed, cause a processor to: write first metadata at a first location designated by a first pointer in a data storage portion of a storage device, wherein the data storage portion comprises a set of blocks designated to store metadata, and wherein the first location designated by the first pointer references a block of the set of blocks that does not contain any valid metadata; determine a number of valid blocks of previously written metadata in a subset of the set of blocks, wherein the subset of the set of blocks comprises a predetermined number of sequential blocks less than a total number of blocks in the set of blocks, and wherein a sequentially first block of the subset of blocks is at a second location designated by a second pointer in the data storage portion of the storage device; and in response to determining that the number of valid blocks of previously written metadata is greater than zero, rewrite the valid previously written metadata in the subset of blocks to a group of one or more sequential blocks of the data storage portion, wherein the block referenced by the first location is sequential with the group of one or more sequential blocks, and wherein a number of blocks in the group of one or more sequential blocks is less than or equal to the number of valid blocks of previously written metadata in the subset of blocks.

### EXAMPLE 21

A device comprising means for performing the method of any combination of examples 1-10.

### EXAMPLE 22

A computer-readable storage medium encoded with instructions that, when executed, cause at least one processor of a computing device to perform the method of any combination of examples 1-10.

### EXAMPLE 23

A device comprising at least one module operable by one or more processors to perform the method of any combination of examples 1-10.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples of the disclosure have been described. Any combination of the described systems, operations, or functions is contemplated. These and other examples are within the scope of the following claims.

1. A method comprising:
writing, by the controller, first metadata at a first location designated by a first pointer in a data storage portion of a storage device, wherein the data storage portion comprises a set of blocks designated to store metadata, and wherein the first location designated by the first pointer references a block of the set of blocks that does not contain any valid metadata;
determining, by the controller, a number of valid blocks of previously written metadata in a subset of the set of blocks, wherein the subset of the set of blocks comprises a predetermined number of sequential blocks less than a total number of blocks in the set of blocks, and wherein a sequentially first block of the subset of blocks is at a second location designated by a second pointer in the data storage portion of the storage device; and
in response to determining that the number of valid blocks of previously written metadata is greater than zero, rewriting, by the controller, the valid previously written metadata in the subset of blocks to a group of one or more sequential blocks of the data storage portion, wherein the block referenced by the first location is sequential with the group of one or more sequential blocks, and wherein a number of blocks in the group of one or more sequential blocks is less than or equal to the number of valid blocks of previously written metadata in the subset of blocks.

2. The method of claim 1, further comprising:
updating, by the controller, the first pointer to reference a second block at a third location, wherein the second location of the third block sequentially succeeds either the first location of the first block or a final sequential block of the group of one or more sequential blocks.

3. The method of claim 2, wherein c comprises an index of the first location, and wherein updating the first location comprises updating c based on:
c=c+i,
wherein 1≦i≦k+1, wherein k comprises the predetermined number of sequential blocks in the subset of blocks, and wherein i comprises one more than the number of blocks in the group of one or more sequential blocks.

4. The method of claim 2, wherein c comprises an index of a page in the first block referenced by the first location, and wherein updating the first location comprises updating c based on:
c=c+q+pg_per_blk,
wherein q comprises a number of valid pages of metadata present in the subset of blocks, and wherein pg_per_blk comprises a total number of pages in a singular block of the set of blocks.

5. The method of claim 1, further comprising:
updating, by the controller, the second pointer to reference a second block at a third location, wherein the second block sequentially succeeds a final sequential block of the subset of blocks.

6. The method of claim 5, wherein p comprises an index of the second location, and wherein updating the second location comprises updating p based on:
p=p+k,
wherein k comprises the predetermined number of sequential blocks in the subset of blocks.

7. The method of claim 6, wherein k equals either 2 or 3.

8. The method of claim 1, further comprising:
updating, by the controller, the second pointer to reference a second block at a third location, wherein p₁ comprises an index of the second location, wherein p₂ comprises an index of the second block, and wherein:
p₂=p₁+k, if k>s, and
p₂=p₁+(k−1), if k=s,
wherein k comprises the predetermined number of sequential blocks in the subset of blocks, and wherein s comprises the number of valid blocks of previously written metadata in the subset of blocks.

9. The method of claim 1, wherein the first metadata comprises an update to previously written metadata stored in the data storage portion of the storage device.

10. The method of claim 1, wherein the first metadata comprises one of a system situation, a file location, a file size, a file creation date, or a third pointer that references the file location.

11. A storage device comprising:
a data storage portion comprising a set of blocks designated to store metadata; and
a controller configured to:
write first metadata at a first location designated by a first pointer in the data storage portion of the storage device, wherein the first location designated by the first pointer references a block of the set of blocks that does not contain any valid metadata;
determine a number of valid blocks of previously written metadata in a subset of the set of blocks, wherein the subset of the set of blocks comprises a predetermined number of sequential blocks less than a total number of blocks in the set of blocks, and wherein a sequentially first block of the subset of blocks is at a second location designated by a second pointer in the data storage portion of the storage device; and
in response to determining that the number of valid blocks of previously written metadata is greater than zero, rewrite the valid previously written metadata in the subset of blocks to a group of one or more sequential blocks of the data storage portion, wherein the block referenced by the first location is sequential with the group of one or more sequential blocks, and wherein a number of blocks in the group of one or more sequential blocks is less than or equal to the number of valid blocks of previously written metadata in the subset of blocks.

12. The storage device of claim 11, wherein the controller is further configured to:
update the first pointer to reference a second block at a third location, wherein the third location of the second block sequentially succeeds either the first location of the first block or a final sequential block of the group of one or more sequential blocks.

13. The storage device of claim 12, wherein c comprises an index of the first location, and wherein the controller being configured to update the first location comprises the controller being configured to update c based on:
c=c+i,
wherein 1≦i≦k+1, wherein k comprises the predetermined number of sequential blocks in the subset of blocks, and wherein i comprises one more than the number of blocks in the group of one or more sequential blocks.

14. The storage device of claim 12, wherein c comprises an index of a page in the first block referenced by the first location, and wherein the controller being configured to update the first location comprises the controller being configured to update c based on:
c=c+q+pg_per_blk,
wherein q comprises a number of valid pages of metadata present in the subset of blocks, and wherein pg per blk comprises a total number of pages in a singular block of the set of blocks.

15. The storage device of claim 11, wherein the controller is further configured to:
update the second pointer to reference a second block at a third location, wherein the second block sequentially succeeds a final sequential block of the subset of blocks.

16. The storage device of claim 15, wherein p comprises an index of the second location, and wherein the controller being configured to update the second location comprises the controller being configured to update p based on:
p=p+k,
wherein k comprises the predetermined number of sequential blocks in the subset of blocks, and wherein k equals either 2 or 3.

17. The storage device of claim 11, further comprising:
update t the second pointer to reference a second block at a third location, wherein p₁ comprises an index of the second location, wherein p₂ comprises an index of the second block, and wherein:
p₂=+k, if k>s, and
p₂=p₁+(k−1), if k=s,
wherein k comprises the predetermined number of sequential blocks in the subset of blocks, and wherein s comprises the number of valid blocks of previously written metadata in the subset of blocks.

18. The storage device of claim 11, wherein the first metadata comprises an update to previously written metadata stored in the data storage portion of the storage device.

19. The storage device of claim 11, wherein the first metadata comprises one of a system situation, a file location, a file size, a file creation date, or a third pointer that references the file location.

20. A computer-readable storage medium storing instructions that, when executed, cause a processor to:
write first metadata at a first location designated by a first pointer in a data storage portion of a storage device, wherein the data storage portion comprises a set of blocks designated to store metadata, and wherein the first location designated by the first pointer references a block of the set of blocks that does not contain any valid metadata;
determine a number of valid blocks of previously written metadata in a subset of the set of blocks, wherein the subset of the set of blocks comprises a predetermined number of sequential blocks less than a total number of blocks in the set of blocks, and wherein a sequentially first block of the subset of blocks is at a second location designated by a second pointer in the data storage portion of the storage device; and
in response to determining that the number of valid blocks of previously written metadata is greater than zero, rewrite the valid previously written metadata in the subset of blocks to a group of one or more sequential blocks of the data storage portion, wherein the block referenced by the first location is sequential with the group of one or more sequential blocks, and wherein a number of blocks in the group of one or more sequential blocks is less than or equal to the number of valid blocks of previously written metadata in the subset of blocks.
